(19) United States
(12) Patent Application Publication
(10) Pub. No.: US 2022/0224025 A1
(43) Pub. Date: Jul. 14, 2022

(54) CONNECTION DEVICE AND CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Akihiro NISHITANI, Mie (JP); Shunya TAKEUCHI, Mie (JP); Yutaka KOBAYASHI, Mie (US); Kenji MAKINO, Mie (JP); Takashi NATSUME, Mie (JP)

(21) Appl. No.: 17/605,969

(22) PCT Filed: Apr. 20, 2020
(86) PCT No.: PCT/JP2020/017018

§ 371 Date: Oct. 22, 2021

(30) Foreign Application Priority Data
May 10, 2019 (JP) 2019-089507
Mar. 6, 2020 (JP) 2020-038709

(51) Int. Cl. H01R 4/48; H01R 13/405; H01R 13/436; H01R 13/514

(52) U.S. Cl. CPC H01R 4/48; H01R 13/405; H01R 2107/00; H01R 13/514; H01R 13/436

(57) ABSTRACT

It is aimed to omit a crimping step without enlargement. A connection device includes a movable-side conductive member and a fixed-side conductive member configured to electrically contact a first conductor and a second conductor serving as connection objects, and a pressing member made of resilient non-metal and configured to give a pressing force in a contact direction to the first conductor, the second conductor, the movable-side conductive member and the fixed-side conductive member.

### TECHNICAL FIELD

The present disclosure relates to a connection device and a connector.

### BACKGROUND

Patent Document 1 discloses a female terminal formed, such as by bending an electrically conductive metal plate. The female terminal includes a box-shaped electrical contact portion, into which a male terminal is inserted, in a front part and a pair of conductor crimping pieces in the form of an open barrel in a rear part. The conductor crimping pieces are crimped and fixed to a conductor exposed by stripping a coating of a coated wire.

Patent Document 2 discloses a female connector provided with a female terminal fitting, first and second obliquely wound coil springs and a female housing for holding the both obliquely wound coil springs. The both obliquely wound coil springs are in the form of coils formed by winding a wire material made of electrically conductive metal a plurality of times. The female terminal fitting is in the form of a flat plate and a core is connected to one end part of the female terminal fitting.

The female terminal fitting is accommodated in the female housing while being sandwiched by the both obliquely wound coil springs. When the female connector is connected to a mating male connector, the first obliquely wound coil spring is sandwiched between a wall surface (contact surface) in the female housing and the female terminal fitting and the second obliquely wound coil spring is sandwiched between a male terminal fitting provided in the male connector and the female terminal fitting. At this time, the second obliquely wound coil spring contacts the female terminal fitting and a terminal connecting portion and the female terminal fitting and the male terminal fitting are electrically connected by resilient restoring forces of the first and second obliquely wound coil springs. Further, the first obliquely wound coil spring is arranged to press the female terminal fitting toward the core.

### PRIOR ART DOCUMENT

### Patent Document

Patent Document 1: JP 2014-241219 A

Patent Document 2: JP 2019-046760 A

### SUMMARY OF THE INVENTION

### Problems to be Solved

In the case of Patent Document 1, a step of crimping the conductor crimping pieces to the conductor is necessary. In the case of Patent Document 2, a connection structure of the female terminal fitting and the male terminal fitting is relatively complicated and a region for disposing the two first and second obliquely wound coil springs has to be secured in the female housing. Further, a structure for insulating the first and second obliquely wound coil springs is possibly separately required. Thus, the connector tends to be enlarged.

A connection device and a connector of the present disclosure were completed on the basis of the above situation and it is aimed to omit a crimping step without enlargement.

### Means to Solve the Problem

The present disclosure is directed to a connection device with a conductive portion configured to electrically contact an electrically conductive member serving as a connection object, and a pressing member made of resilient non-metal, the pressing member giving a pressing force in a contact direction to the electrically conductive member and the conductive portion.

### Effect of the Invention

According to the present disclosure, it is possible to omit a crimping step without enlargement.

### BRIEF DESCRIPTION OF THE DRAWINGS

FIG. 1 is an exploded perspective view of a female connector constituting a connector of a first embodiment.

FIG. 2 is an exploded perspective view of a male connector constituting the connector.

FIG. 3 is a side view in section showing a state where a first conductor is connected to a movable-side conductive member and a fixed-side conductive member.

FIG. 4 is a section along X-X of FIG. 3.

FIG. 5 is a front view of a housing with a front member removed.

FIG. 6 is a partial enlarged side view in section showing a state where the first conductor and a second conductor are connected.

FIG. 7 is a perspective view of a pressing member.

FIG. 8 is a perspective view of the movable-side conductive member.

FIG. 9 is a perspective view of the fixed-side conductive member.

FIG. 10 is a perspective view of a movable-side conductive member of a second embodiment.

FIG. 11 is a partial enlarged side view in section showing a state where a first conductor and a second conductor are connected in a connector of a third embodiment.

FIG. 12 is a perspective view of a fixed-side conductive member of a fourth embodiment.

FIG. 13 is a perspective view of a pressing member and movable-side conductive members of a fifth embodiment.

FIG. 14 is a perspective view of a pressing member and movable-side conductive members of a sixth embodiment.

FIG. 15 is a perspective view of a pressing member and movable-side conductive members of a seventh embodiment.

FIG. 16 is a perspective view of a connection device according to an eighth embodiment.

FIG. 17 is a side view in section showing a state where electrically conductive members of a first wire and a second wire are connected via conductive portions of the connection device.

FIG. 18 is a section along Y-Y of FIG. 17.

FIG. 19 is a view, corresponding to FIG. 15, in a state before the electrically conductive member enters an entrance portion.

FIG. 20 is a side view in section of a connector.

FIG. 21 is a side view in section showing a state where a connector housing of the connector is connected to a mating connector housing.

FIG. 22 is a plan view in section showing the state where the connector housing of the connector is connected to the mating connector housing.

FIG. 23 is a back view in section showing the state where the connector housing of the connector is connected to the mating connector housing.

FIG. 24 is a perspective view of a molded body.

FIG. 25 is a perspective view of a first modification of a connection device according to another embodiment.

FIG. 26 is a perspective view of a second modification of a connection device according to another embodiment.

### DETAILED DESCRIPTION TO EXECUTE THE INVENTION

[Description of Embodiments of Present Disclosure]

First, embodiments of the present disclosure are listed and described.

(1) The connection device of the present disclosure includes a conductive portion configured to electrically contact an electrically conductive member serving as a connection object, and a pressing member made of resilient non-metal, the pressing member giving a pressing force in a contact direction to the electrically conductive member and the conductive portion. According to this configuration, since the conductive portion and the electrically conductive member are pressed in the contact direction by the pressing member, a contact pressure between the conductive portion and the electrically conductive member is secured. Here, since conductor crimping pieces can be omitted from the connection device, a step of crimping the conductive portion to the electrically conductive member needs not be performed. Since the resilient pressing member presses the conductive portion and the electrically conductive member, the structure of the pressing member does not become particularly complicated. Further, since the pressing member is made of non-metal, a structure for insulation needs not be provided separately from the pressing member. As a result, the enlargement of the connection device can be avoided.

(2) In (1), preferably, the conductive portion includes a first conductive portion and a second conductive portion arranged to face the first conductive portion across the electrically conductive member. According to this configuration, since a plurality of contact points by the first and second conductive portions are secured for the electrically conductive member, contact reliability is high. Further, since the first and second conductive portions are arranged across the electrically conductive member, the first and second conductive portions can be brought into contact with the electrically conductive member even if only one pressing member is provided.

(3) In (2), preferably, a supporting portion is provided which supports the pressing member, the first conductive portion is displaceable integrally with the pressing member and the second conductive portion is fixed to the supporting portion. According to this configuration, the first conductive portion functions as a movable contact point and the second conductive portion functions as a fixed contact point. Since only one of the first and second conductive portions is the conductive portion having the contact point configured to be displaced, contact pressures of the first and second conductive portions with the electrically conductive member are stable as compared to the case where the two contact points on opposite sides of the electrically conductive member are both displaced.

(4) In (2), preferably, a second pressing member is provided which is located on a side opposite to the pressing member across the electrically conductive member, the first conductive portion is displaceable integrally with the pressing member and the second conductive portion is displaceable integrally with the second pressing member. According to this configuration, since contact loads of the first and second conductive portions with the electrically conductive member are obtained by a resilient force of the pressing member and a resilient force of the second pressing member, high contact pressures can be secured.

(5) In (2) to (4), preferably, at least one of the first and second conductive portions is formed with a projection-like contact point portion configured to contact the electrically conductive member. According to this configuration, a contact area of the electrically conductive member and the projection-like contact point portion is smaller than a contact area when the first and second conductive portions are brought into surface contact with the electrically conductive member. Since the contact pressure between the electrically conductive member and the contact point portion increases in this way, connection reliability is excellent.

(6) In (3), preferably, a projection-like contact point portion configured to contact the electrically conductive member is formed on only the second conductive portion, out of the first and second conductive portions. According to this configuration, since the shape of the conductive portion configured to be displaced integrally with the pressing member can be simplified, a pressing function of the pressing member can be prevented from being disturbed due to the complicated shape of the conductive portion.

(7) In (1) to (6), preferably, a plurality of the conductive portions are mounted in one pressing member. According to this configuration, the number of the pressing members can be reduced.

(8) In (2) to (7), preferably, at least either a plurality of the first conductive portions or a plurality of the second conductive portions are conductively coupled to each other. According to this configuration, a joint connector can be configured by the plurality of first conductive portions and the plurality of second conductive portions.

(9) In (1), preferably, the pressing member includes an entrance portion, the electrically conductive member being able to enter the entrance portion, and the conductive portion is provided in the entrance portion. According to this configuration, the electrically conductive member and the conductive portion can be easily connected only by causing the electrically conductive member to enter the pressing member.

(10) In (9), preferably, the pressing member includes a plurality of entrance end parts constituting end parts of the entrance portion, and the conductive portion is arranged to extend between the plurality of entrance end parts. According to this configuration, a plurality of the electrically conductive members can enter the entrance portion through the respective entrance end parts and be connected to each other via the conductive portion.

(11) In (9) or (10), preferably, the entrance portion is a space penetrating through the pressing member in an entering direction of the electrically conductive member. According to this configuration, since the end parts on both sides of the pressing member are open, the electrically conductive members can be electrically connected by inserting the electrically conductive members into the pressing member from the both sides.

(12) A connector preferably includes the connection device of (1) to (11) described above, a connector housing configured to accommodate the connection device, the electrically conductive member, and a holding member configured to hold the electrically conductive member, the holding member including a locked portion, and the connector housing including a lock portion configured to lock the locked portion and restrict escape of the holding member from the connector housing. According to this configuration, the escape of the holding member from the connector housing is restricted and, consequently, the escape of the connection device is also restricted by the lock portion locking the locked portion. The holding member including the locked portion is provided separately from the connection device. Thus, the locked portion can be omitted from the connection device and the connection device can have a simple structure and a small size.

(13) In (12), preferably, the holding member is made of mold resin configured to collectively mold a plurality of the electrically conductive members. According to this configuration, the plurality of electrically conductive members can be integrally handled via the holding member. Further, the plurality of electrically conductive members can be aligned and arranged by the holding member.

[Details of Embodiment of Present Disclosure]

### First Embodiment

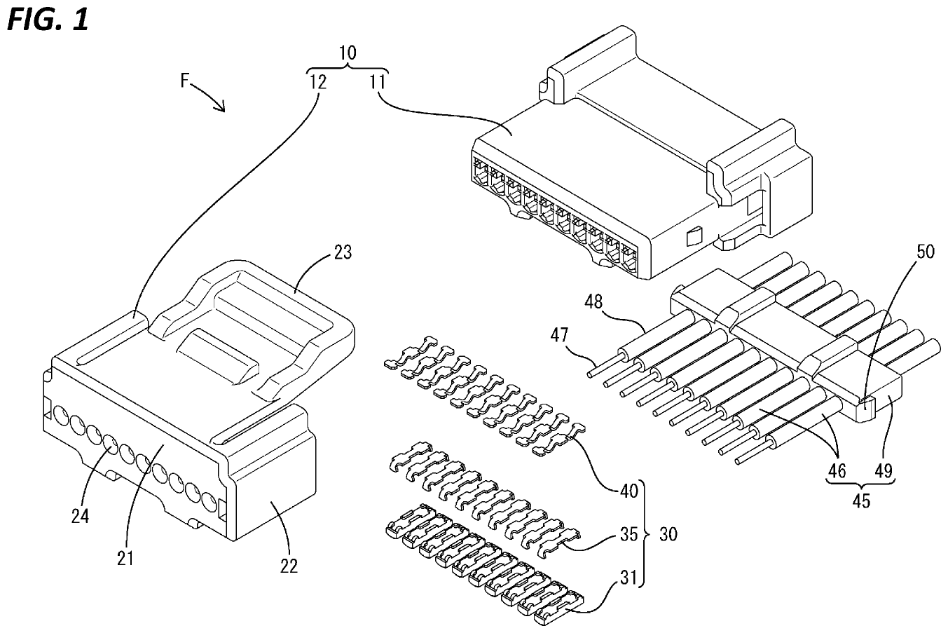

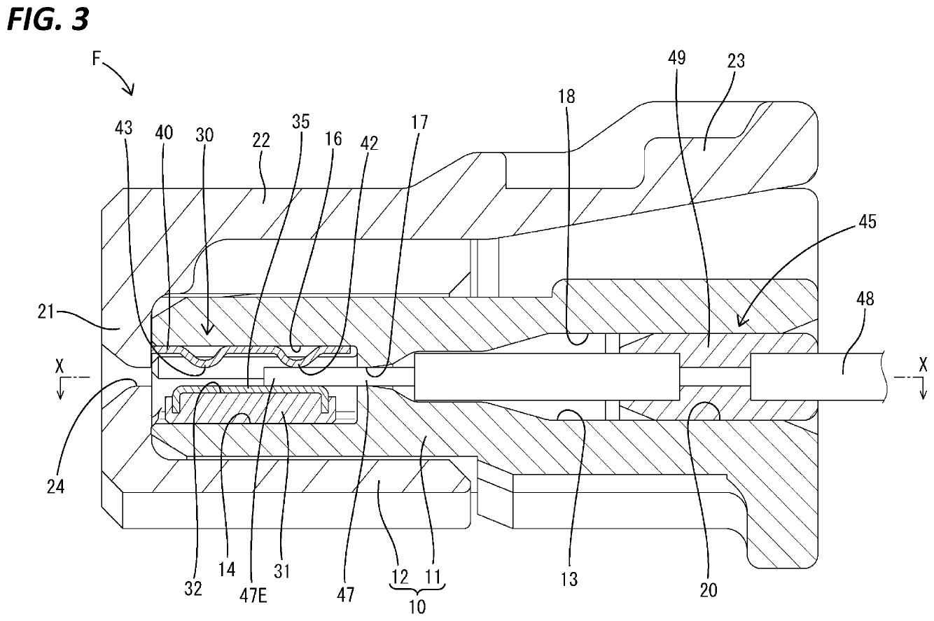

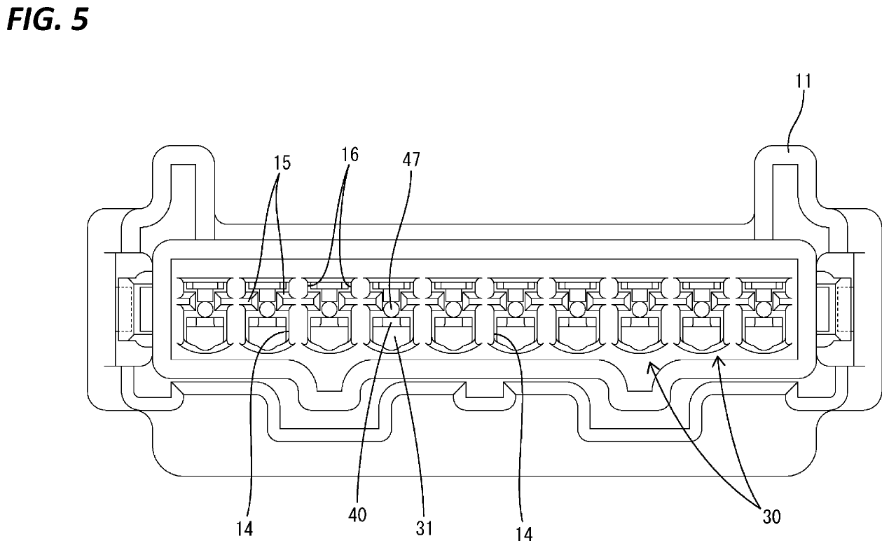

A first embodiment embodying a connector and a connection device 30 of the present disclosure is described with reference to FIGS. 1 to 9. Note that the present invention is not limited to these illustrations and is intended to be represented by claims and include all changes in the scope of claims and in the meaning and scope of equivalents. In the first embodiment, a left side in FIGS. 3, 4 and 6 is defined as a front side concerning a front-rear direction. Upper and lower sides shown in FIGS. 1 to 3, 5 and 6 are directly defined as upper and lower sides concerning a vertical direction. Left and right sides shown in FIG. 5 are directly defined as left and right sides concerning a lateral direction. The lateral direction is used as a synonym for a width direction.

The connector of the first embodiment includes a female connector F and a male connector M to be connected to each other. The female connector F includes one female housing 10, a connection device 30 accommodated in the female housing 10 and one first wire module 45.

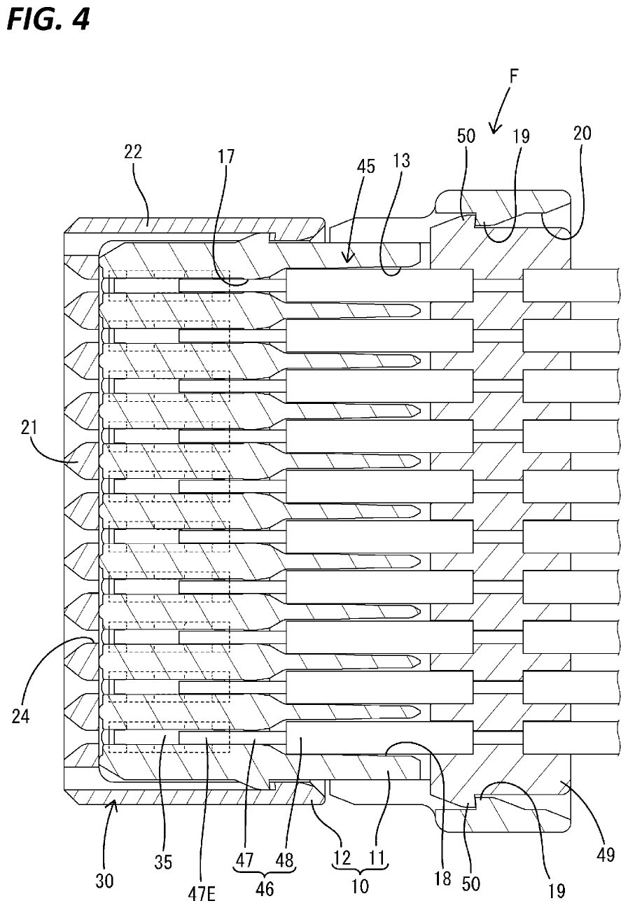

The female housing 10 is made of a synthetic resin material and includes, as shown in FIGS. 3 and 4, a housing body 11 and a front member 12 to be mounted on the housing body 11 from front. The housing body 11 includes a plurality of cavities 13 arranged in parallel in the lateral direction and one holding space 20 open in the rear end surface of the housing body 11. The cavity 13 constitutes a space elongated in the front-rear direction as a whole. A connecting portion 14 open in the front end surface of the housing body 11 is formed in a front end part of the cavity 13. The inside of the connecting portion 14 functions as a connection space for the connection of a first conductor 47 and a second conductor 66.

As shown in FIG. 5, the connecting portion 14 is bilaterally symmetrically shaped in a front view of the female housing 10. The connecting portion 14 is formed with a pair of bilaterally symmetrical positioning portions 15. The pair of positioning portions 15 project inward in the width direction from both left and right inner wall surfaces of the connecting portion 14. In the vertical direction, the positioning portions 15 are arranged at a position above a center of the connecting portion 14. A pair of bilaterally symmetrical groove portions 16 extending in the front-rear direction are formed in upper end parts of the inner side surfaces of the connecting portion 14, i.e. regions above the positioning portions 15. The groove portions 16 are open in the front end surface of the housing body 11. An interval between projecting ends of both left and right positioning portions 15 is set equal to or slightly larger than outer diameters of the first and second conductors 47, 66 to be described later.

As shown in FIGS. 3 and 4, a guide portion 17 with a guide hole having a smaller diameter than the connecting portion 14 is formed in a region of the cavity 13 connected to the rear end of the connecting portion 14. An inserting portion 18 having a larger diameter than the guide portion 17 is formed in a region of the cavity 13 from the rear end of the guide portion 17 to the rear end of the cavity 13. The holding space 20 is in the form of a slit open in the rear end surface of the housing body 11 and long in the lateral direction. The holding space 20 communicates with the rear ends of all the plurality of cavities 13 (inserting portions 18). As shown in FIG. 4, a pair of left and right retaining projections 19 are formed on both left and right end parts of the holding space 20.

The front member 12 is in the form of a cap and includes, as shown in FIGS. 3 and 4, a front wall portion 21 for covering the front surface of the housing body 11, a peripheral wall portion 22 for surrounding a front end side region of the housing body 11 and a lock arm 23 extending rearward from the front wall portion 21 and constituting a part of the peripheral wall portion 22. Openings in the front ends of the plurality of connecting portions 14 are covered by the front wall portion 21. A plurality of insertion holes 24 penetrating through the front wall portion 21 in the front-rear direction are formed at a plurality of positions of the front wall portion 21 corresponding to the respective cavities 13 (connecting portions 14). Each insertion hole 24 has a circular cross-section having a smaller diameter than the connecting portion 14.

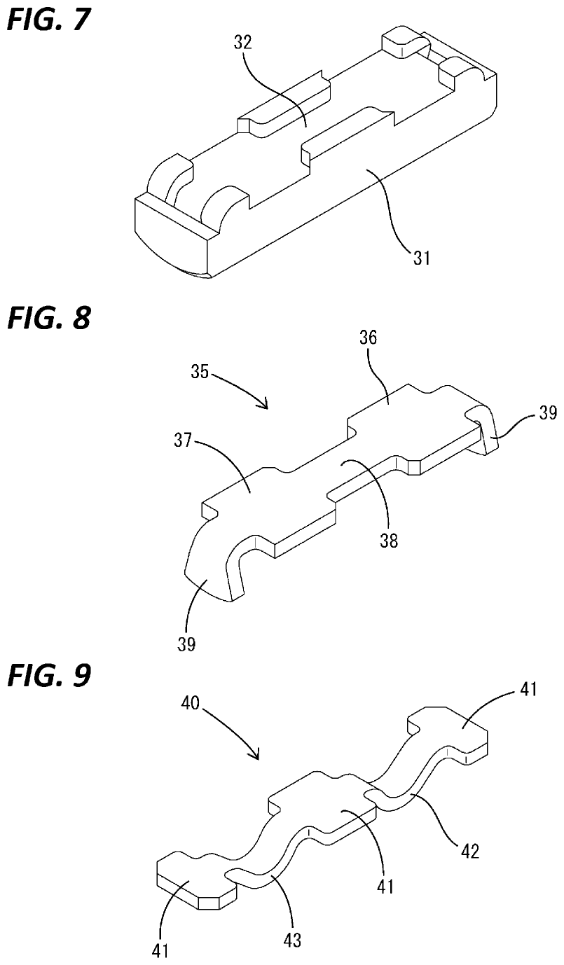

The connection device 30 includes a plurality of pressing members 31, a plurality of movable-side conductive members 35 and a plurality of fixed-side conductive members 40. The pressing member 31 is made of an electrically insulating rubber material and resiliently deformable. The plurality of pressing members 31 are individually accommodated into the plurality of connecting portions 14. The pressing member 31 is arranged while being placed on the bottom surface of the connecting portion 14. As shown in FIG. 7, the pressing member 31 is a single component having a rectangular parallelepiped shape long in the front-rear direction as a whole. A maximum width of the pressing member 31 is set larger than the interval between the projecting ends of the pair of positioning portions 15. An accommodation recess 32 for accommodating the movable-side conductive member 35 to be described later is formed on the upper surface of the pressing member 31.

The movable-side conductive member 35 is formed of a plate member, for example, made of metal such as copper or aluminum and, as shown in FIG. 8, has a shape long in the front-rear direction as a whole. The movable-side conductive member 35 is a single component including a first contact portion 36, a second contact portion 37 arranged forward of the first contact portion 36, a coupling portion 38 coupling the first and second contact portions 36, 37 and a pair of front and rear bent end parts 39. The front end of the first contact portion 36 is connected to the rear end of the coupling portion 38, and the rear end of the second contact portion 37 is connected to the front end of the coupling portion 38. The bent end part 39 is bent to extend downward from the rear end of the first contact portion 36. The bent end part 39 is bent to extend downward from the front end of the second contact portion 37.

The movable-side conductive member 35 is fixed to the pressing member 31 while being fit into the accommodation recess 32 on the upper surface of the pressing member 31. Widths of the first and second contact portions 36, 37 are larger than those of the coupling portion 38 and the bent end parts 39 and equal to that of the pressing member 31. The widths of the pressing member 31 and the first and second contact portions 36, 37 are set larger than the interval between the projecting ends of the pair of positioning portions 15. The movable-side conductive member 35 and the pressing member 31 are accommodated in a region of the connecting portion 14 below the positioning portions 15.

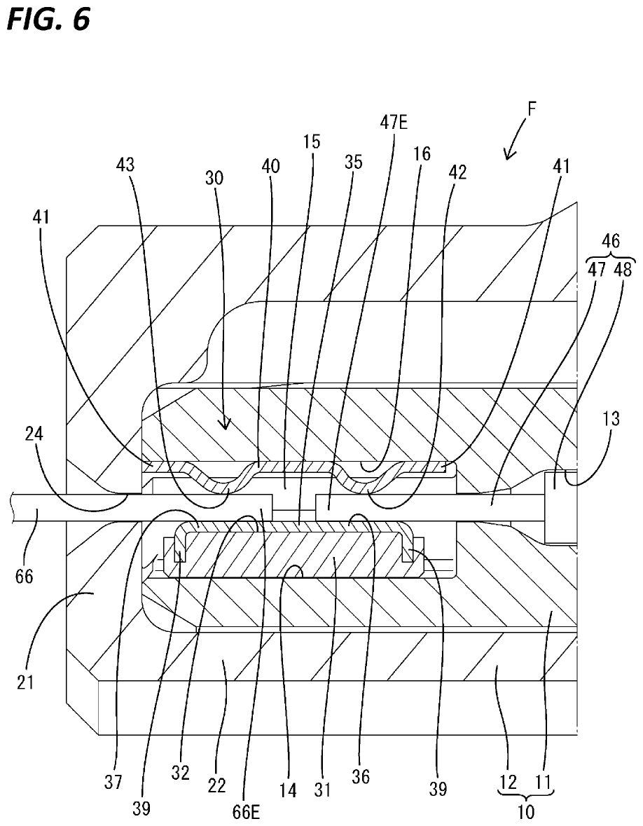

The fixed-side conductive member 40 is formed of a plate member, for example, made of metal such as copper or aluminum, similarly to the movable-side conductive member 35. As shown in FIG. 9, the fixed-side conductive member 40 is a single component including three mounting portions 41 arranged at intervals in the front-rear direction, a first contact point portion 42 and a second contact point portion 43 located forward of the first contact point portion 42. The front end of the first contact point portion 42 is connected to the rear end of the mounting portion 41 located in a middle. The rear end of the first contact point portion 42 is connected to the front end of the mounting portion 41 located on a rear side. The front end of the second contact point portion 43 is connected to the rear end of the mounting portion 41 located on a front side. The rear end of the second contact point portion 43 is connected to the front end of the mounting portion 41 located in the middle. As shown in FIG. 6, the first and second contact point portions 42, 43 have a curved shape bulging downward and projecting further downward than the mounting portions 41 in a side view of the fixed-side conductive member 40.

The fixed-side conductive member 40 is fixedly mounted in an upper end part inside the connecting portion 14 by fitting both left and right side edge parts of the three mounting portions 41 into the groove portions 16 of the connecting portion 14. The fixed-side conductive member 40 is located above the pressing member 31 and the movable-side conductive member 35 and facing the movable-side conductive member 35 across a predetermined interval in the vertical direction. The first and second contact point portions 42, 43 project toward the movable-side conductive member 35. Vertical intervals between the lower ends of the first and second contact point portions 42, 43 and the upper surface of the movable-side conductive member 35 in a state where the pressing member 31 is not resiliently deformed are set smaller than the outer diameters of the first and second conductors 47, 66 to be described later. Widths of the first and second contact point portions 42, 43 are set smaller than the interval between the projecting ends of the pair of positioning portions 15. In a front view of the female connector F, the first and second contact point portions 42, 43 are arranged between the pair of positioning portions 15.

As shown in FIG. 1, the first wire module 45 is formed by integrating a plurality of first coated wires 46 and one first holding member 49. The first coated wire 46 is such that the first conductor 47 is surrounded with a first insulation coating 48. The first conductor 47 is a single core made of a metal material such as copper or aluminum and has such rigidity to maintain a circular cross-section. The outer diameter of the first conductor 47 is set smaller than the widths of the first and second contact point portions 42, 43 and smaller than the interval between the projecting ends of the pair of positioning portions 15. In an end part of the first coated wire 46, the insulation coating is removed to expose the first conductor 47. An exposed part of the first conductor 47 is defined as a first connecting end part 47E.

The first holding member 49 has a flat shape along the width direction and collectively holds intermediate stripped parts of the plurality of first coated wires 46 arranged side by side in the lateral direction as shown in FIG. 1. The first holding member 49 is a molded body formed by covering the plurality of coated wires 46 with a resin. The plurality of first coated wires 46 penetrate through the holding member 49 in the front-rear direction and held positioned at fixed intervals in the lateral direction. A pair of left and right locking projections 50 are formed on both left and right side surfaces of the first holding member 49.

The first wire module 45 is assembled into the holding space 20 of the housing body 11 from behind the female housing 10. With the first wire module 45 assembled with the female housing 10, the locking projections 50 of the first holding member 49 are locked to the retaining projections 19 of the female housing 10 as shown in FIG. 4, whereby the first wire module 45 is held retained in the female housing 10.

In an assembling process, the first connecting end parts 47E of the plurality of first conductors 47 are successively passed through the guide portions 17 and the inserting portions 18, enter the connecting portions 14 and are sandwiched between the first contact portions 36 and the first contact point portions 42. In the state where the pressing member 31 is not resiliently deformed, an interval between the first contact portion 36 and the first contact point portion 42 is smaller than the outer diameter of the first connecting end part 47E. Thus, the first connecting end part 47E displaces the first contact portion 36 downward and resiliently deforms the pressing member 31 to vertically squeeze the pressing member 31. By a resilient restoring force of the pressing member 31, the first conductor 47 and the first contact portion 36 are conductively connected with a predetermined contact pressure and the first conductor 47 and the first contact point portion 42 are conductively connected with a predetermined contact pressure. Since the first conductor 47 is accommodated between the pair of positioning portions 15, a relative displacement of the first conductor 47 in the width direction with respect to the movable-side conductive member 35 and the fixed-side conductive member 40 is prevented. In this way, the first conductor 47 and the movable-side conductive member 35 are stably connected, and the first conductor 47 and the fixed-side conductive member 40 are also stably connected.

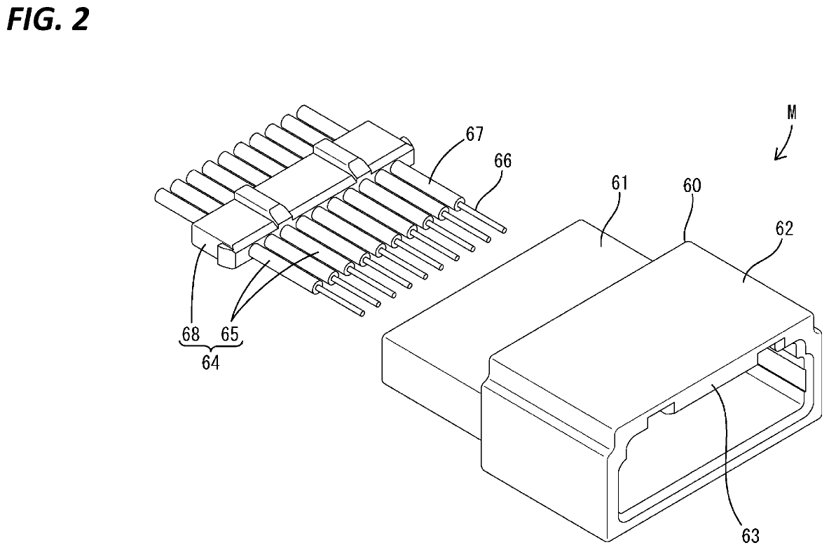

As shown in FIG. 2, the male connector M includes one male housing 60 and one second wire module 64. The male housing 60 is a single component made of synthetic resin and including a housing portion 61 and a tubular receptacle 62 projecting from the housing portion 61. A lock portion 63 to be locked to the lock arm 23 of the female connector F is formed on the inner surface of an upper wall portion of the receptacle 62. Although not shown, the housing portion 61 includes a plurality of guide portions 17, a plurality of inserting portions 18 and a holding space 20 similar to the plurality of guide portions 17, the plurality of inserting portions 18 and the holding space 20 of the female connector F. The housing portion 61 does not include parts equivalent to the connecting portions 14 of the female connector F.

The second wire module 64 is formed by integrating a plurality of second coated wires 65 and one second holding member 68, similarly to the first wire module 45. The second coated wire 65 is such that the second conductor 66 is surrounded with a second insulation coating 67. The second conductor 66 is a single core made of a metal material such as copper or aluminum and has such rigidity to maintain a circular cross-section. The outer diameter of the second conductor 66 is equal to the outer diameter of the first conductor 47. In an end part of the second coated wire 65, the second insulation coating 67 is removed to expose the second conductor 66. An exposed part of the second conductor 66 is defined as a second connecting end part 66E. The second wire module 64 is assembled with the housing portion 61 from behind the male connector M. With the second wire module 64 assembled with the male housing 60, the second connecting end parts 66E of the second conductors 66 project into the receptacle 62 from the front surface of the housing portion 61.

In connecting the male connector M and the female connector F, the female connector F is fit into the receptacle 62. In a fitting process, the second connecting end part 66E of the second conductor 66 enters the connecting portion 14 through the insertion hole 24 and is inserted between the second contact portion 37 and the second contact point portion 43 to resiliently deform the pressing member 31 and vertically squeeze the pressing member 31. By a resilient restoring force of the pressing member 31, the second conductor 66 and the second contact portion 37 are conductively connected with a predetermined contact pressure and the second conductor 66 and the second contact point portion 43 are conductively connected with a predetermined contact pressure. Since the second connecting end part 66E of the second conductor 66 having entered the connecting portion 14 is positioned in the width direction by the pair of positioning portions 15, there is no possibility that the second connecting end part 66E is inclined in the width direction and shifted in the width direction.

The male connector M constituting the connector of the first embodiment includes the female housing 10, into which the first and second conductors 47, 66 are insertable, and the connection device 30 to be accommodated into the female housing 10. The connection device 30 includes the pressing members 31, the movable-side conductive members 35 and the fixed-side conductive members 40. The movable-side conductive members 35 are accommodated into the female housing 10 and can electrically contact the first conductive members 47 and the second conductors 66. The fixed-side conductive members 40 are also accommodated into the female housing 10 and can electrically contact the first conductive members 47 and the second conductors 66. The pressing members 31 are made of a resilient insulating material and accommodated in the female housing 10. The pressing members 31 give pressing forces in a contact direction to the movable-side conductive members 35 and the first and second conductors 47, 66 inserted into the female housing 10. The pressing members 31 give pressing forces in a contact direction to the fixed-side conductive members 40 and the first and second conductors 47, 66 inserted into the female housing 10.

Since the movable-side conductive members 35 and the first conductors 47 contact each other by the resilient pressing forces in the contact direction given from the pressing members 31, a step of crimping the first conductors 41 and the movable-side conductive members 35 is not necessary. Since the fixed-side conductive members 40 and the first conductors 47 contact each other by the resilient pressing forces in the contact direction given from the pressing members 31, a step of crimping the first conductors 47 and the fixed-side conductive members 40 is not necessary. Since the pressing members 31 are made of the insulating material and a structure for insulation needs not be provided separately from the pressing members 31, it is realized to avoid the enlargement of the female connector F. Therefore, the connector of the first embodiment can omit the crimping step without enlargement.

The female housing 10 is formed with the positioning portions 15 for positioning the first and second conductors 47, 66 in the width direction orthogonal to both axial directions (front-rear direction) of the first and second conductors 47, 66 and a pressing direction (vertical direction) of the pressing members 31. Since the first and second conductors 47, 66 are positioned in the width direction by the positioning portions 15, there is no possibility that the first conductors 47 and the second conductors 66 deviate from the movable-side conductive members 35 and the fixed-side conductive members 40 in the width direction. Therefore, the contact reliability of the movable-side conductive members 35 and the fixed-side conductive members 40 with the first conductors 47 is excellent and the contact reliability of the movable-side conductive members 35 and the fixed-side conductive members 40 with the second conductors 66 is excellent.

The connection device 30 includes the movable-side conductive members 35 and the fixed-side conductive members 40. The movable-side conductive members 35 and the fixed-side conductive members 40 are arranged to face each other across the first and second conductors 47, 66. According to this configuration, since a plurality of contact points with the first and second conductors 47, 66 can be secured by the movable-side conductive members 35 and the fixed-side conductive members 40, contact reliability is high. Further, the movable-side conductive members 35 and the fixed-side conductive members 40 are arranged to sandwich the first and second conductors 47, 66. Thus, even if only one pressing member 31 is provided, the movable-side conductive member 35 can be brought into contact with the first and second conductors 47, 66 and the fixed-side conductive member 40 can be brought into contact with the first and second conductors 47, 66.

The connection device 30 includes the connecting portions 14 for supporting the pressing members 31. The movable-side conductive member 35 is displaceable integrally with the pressing member 31 and the fixed-side conductive member 40 is fixed to the connecting portion 14. According to this configuration, the first and second contact portions 36, 37 of the movable-side conductive member 35 function as movable contact points, and the first and second contact point portions 42, 43 of the fixed-side conductive member 40 function as fixed contact points.

Since only one conductive member (movable-side conductive member 35), out of two conductive members (movable-side conductive member 35 and fixed-side conductive member 40), is provided with displaceable contact points (first and second contact portions 36, 37), the contact pressures of the movable-side conductive member 35 and the fixed-side conductive member 40 with the first and second conductors 47, 66 are stabilized as compared to the case where the first and second conductors 47, 66 are sandwiched by two movable-side conductive members 35 (first and second contact portions 36, 37) configured to be displaced without providing the fixed-side conductive member 40 (first and second contact point portions 42, 43) configured not to be displaced.

The fixed-side conductive member 40 is formed with the first and second contact point portions 42, 43 in the form of projections configured to contact the first and second conductors 47, 66. According to this configuration, a contact area of the first conductor 47 and the projection-like first contact point portion 42 is smaller than a contact area when the fixed-side conductive member 40 comes into surface contact with the first conductor 47. A contact area of the second conductor 66 and the projection-like second contact point portion 43 is smaller than a contact area when the fixed-side conductive member 40 comes into surface contact with the second conductor 66. In this way, the contact pressure of the first conductor 47 and the first contact point portion 42 increases and the contact pressure of the second conductor 66 and the second contact point portion 43 increases, wherefore connection reliability is excellent.

The projection-like first and second contact point portions 42, 43 configured to contact the first and second conductors 47, 66 are formed only on the fixed-side conductive member 40, out of the movable-side conductive member 35 and the fixed-side conductive member 40. According to this configuration, since the shape of the movable-side conductive member 35 configured to be displaced integrally with the pressing member 31 can be simplified, a pressing function of the pressing member 31 can be prevented from being disturbed due to the complicated shape of the movable-side conductive member 35.

### Second Embodiment

A second embodiment of the present disclosure is described with reference to FIG. 10. A movable-side conductive member 70 of the second embodiment includes a rib-like contact point portion 71. The contact point portion 71 linearly extends over the upper surface of a first contact portion 36, the upper surface of a coupling portion 38 and the upper surface of a second contact portion 37. The contact point portion 71 extends in a direction parallel to a sliding direction of a first conductor 47 (not shown) and a second conductor 66 (not shown) on the movable-side conductive member 70. Since the other components are the same as in the first embodiment, the same components are denoted by the same reference signs and the structures, functions and effects thereof are not described.

A contact area of the first conductor 41 and the projection-like contact point portion 71 and a contact area of the second conductor 66 and the projection-like contact point portion 71 are smaller than the contact areas when the movable-side conductive member 35 of the first embodiment comes into surface contact with the first and second conductors 47, 66. In this way, a contact pressure of the first conductor 47 and the contact point portion 71 and a contact pressure of the second conductor 66 and the contact point portion 71 increase, wherefore connection reliability is excellent.

### Third Embodiment

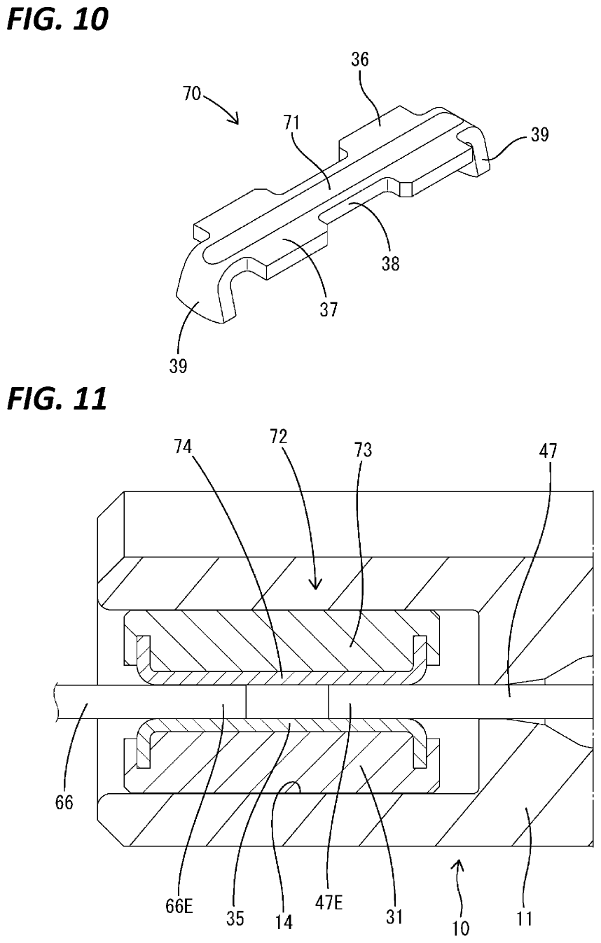

A third embodiment embodying a connection device 72 of the present disclosure is described with reference to FIG. 11. The connection device 72 of the third embodiment includes second pressing members 73 located on a side opposite to pressing members 31 across first conductors 47 and second conductors 66. The second pressing member 73 is made of a resilient material, similarly to the pressing member 31, and shaped to be vertically symmetrical with the pressing member 31. The second pressing member 73 is fixed to the upper surface of a connecting portion 14. A second movable-side conductive member 74 is integrally displaceably fixed to the lower surface of the second pressing member 73. The second movable-side conductive member 74 is made of a metal material, similarly to the movable-side conductive member 35, and shaped to be vertically symmetrical with the movable-side conductive member 35.

According to this configuration, contact loads of the movable-side conductive member 35 and the second movable-side conductive member 74 with the first conductor 47 are obtained by a resilient force of the pressing member 31 and a resilient force of the second pressing member 73. Contact loads of the movable-side conductive member 35 and the second movable-side conductive member 74 with the second conductor 66 are also obtained by the resilient force of the pressing member 31 and the resilient force of the second pressing member 73. Therefore, high contact pressures can be secured. Since the other components are the same as in the first embodiment, the same components are denoted by the same reference signs and the structures, functions and effects thereof are not described.

### Fourth Embodiment

A fourth embodiment embodying the present disclosure is described with reference to FIG. 12. In the fourth embodiment, a joint terminal 75 as a single component is configured by coupling a plurality of fixed-side conductive members 40 via linking portions 76. The linking portions 76 couple mounting portions 41 arranged in the lateral direction to each other. A plurality of first conductors 47 and a plurality of second conductors 66 can be made conductive by the joint terminal 75. That is, a joint connector can be configured by the joint terminal 75. Since the other components are the same as in the first embodiment, the same components are denoted by the same reference signs and the structures, functions and effects thereof are not described.

### Fifth Embodiment

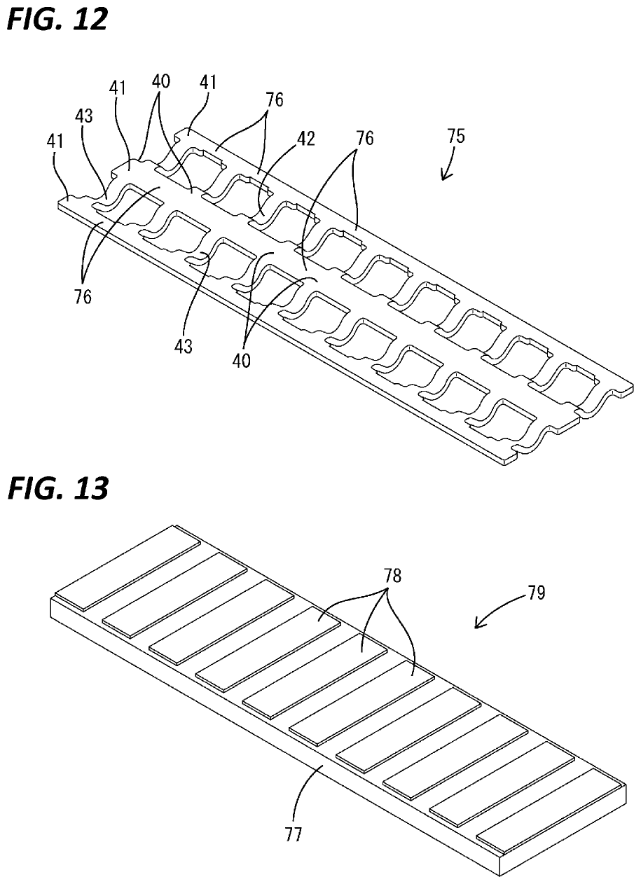

A fifth embodiment embodying the present disclosure is described with reference to FIG. 13. In the fifth embodiment, a pressing module 79 is configured by fixing a plurality of movable-side conductive members 78 to the upper surface of one pressing member 77. The pressing member 77 has a width extending over a plurality of connecting portions 14 (not shown). A female housing 10 (not shown) is formed with a communication groove (not shown) allowing the plurality of connecting portions 14 to communicate with each other. The pressing module 79 is mounted into the female housing 10 by accommodating the pressing member 77 into the communication groove and the plurality of connecting portions 14. The plurality of movable-side conductive members 78 are independently accommodated into the plurality of connecting portions 14.

A plurality of first conductors 47 (not shown) are independently connected to the plurality of movable-side conductive members 78 and a plurality of second conductors 66 (not shown) are independently connected to the plurality of movable-side conductive members 78. By using the pressing module 79 of the fifth embodiment, the number of the pressing members 77 can be reduced. Since the other components are the same as in the first embodiment, the same components are denoted by the same reference signs and the structures, functions and effects thereof are not described.

### Sixth Embodiment

A sixth embodiment embodying the present disclosure is described with reference to FIG. 14. In the sixth embodiment, one joint terminal 82 is configured by coupling a plurality of movable-side conductive members 80 by linking portions 81. This joint terminal 82 is fixed to the upper surface of a pressing member 77. The pressing member 77 has the same configuration as in the fifth embodiment. A pressing module 83 is configured by one joint terminal 82 and one pressing member 77.

By using the pressing module 83 in which the plurality of movable-side conductive members 80 are conductorly coupled to each other, a joint connector can be configured and a plurality of first conductors 47 and a plurality of second conductors 66 can be made conductive. Since the other components are the same as in the fifth embodiment, the same components are denoted by the same reference signs and the structures, functions and effects thereof are not described.

### Seventh Embodiment

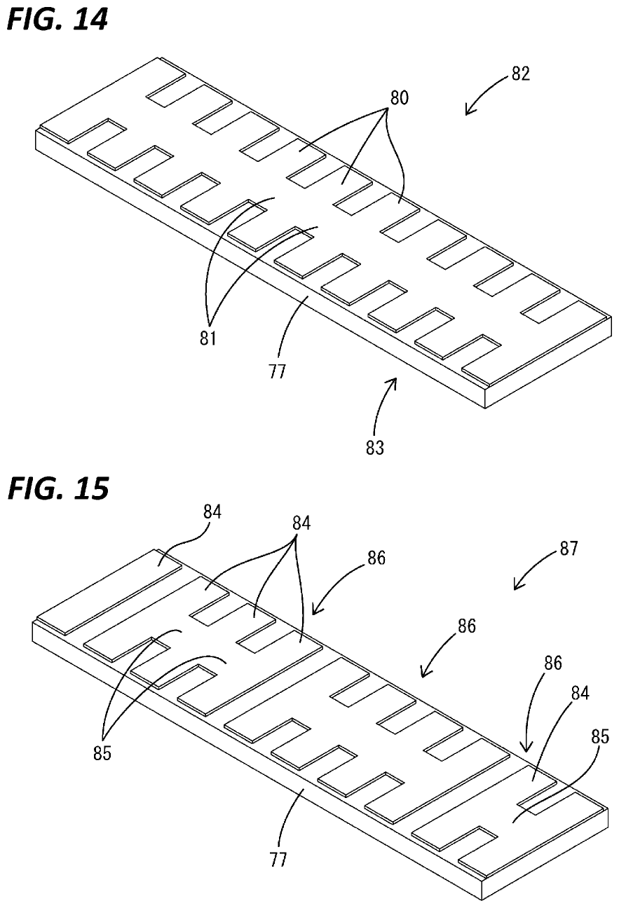

A seventh embodiment embodying the present disclosure is described with reference to FIG. 15. In the seventh embodiment, a joint terminal 86 is configured by coupling a plurality of movable-side conductive members 84 by linking portions 85. A plurality of the joint terminals 86 and one movable-side conductive member 84 are fixed to the upper surface of a pressing member 77. The pressing member 77 has the same configuration as in the fifth and sixth embodiments. A pressing module 87 is configured by the plurality of joint terminals 86, one movable-side conductive member 884 and one pressing member 77.

By using the joint terminals 86 in which the plurality of movable-side conductive members 84 are conductively coupled, a joint connector can be configured and a plurality of first conductors 47 (not shown) and a plurality of second conductors 66 (not shown) can be made conductive. Since the other components are the same as in the fifth and sixth embodiments, the same components are denoted by the same reference signs and the structures, functions and effects thereof are not described.

### Eighth Embodiment

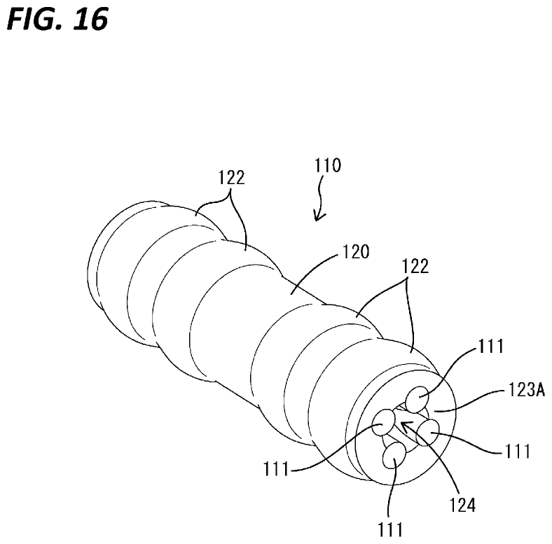

An eighth embodiment embodying a connection device 110 and a connector 160 of the present disclosure is described with reference to FIGS. 16 to 26. Note that the present invention is not limited to this illustration and is intended to be represented by claims and include all changes in the scope of claims and in the meaning and scope of equivalents.

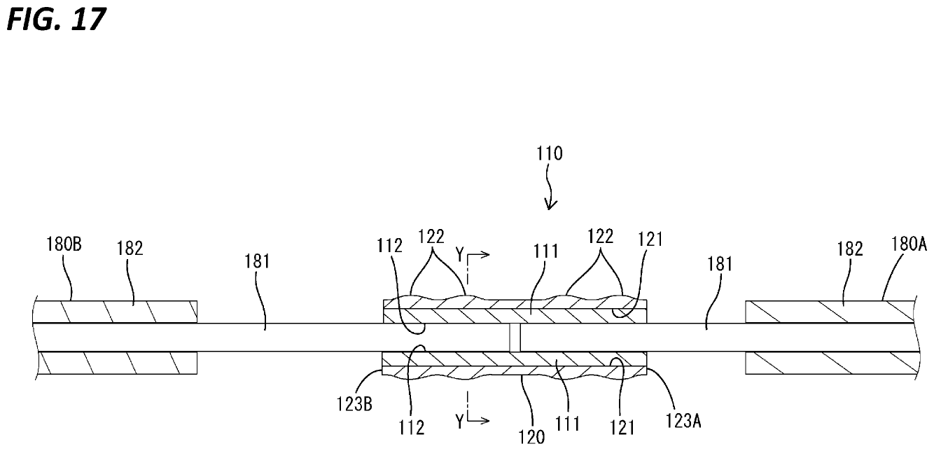

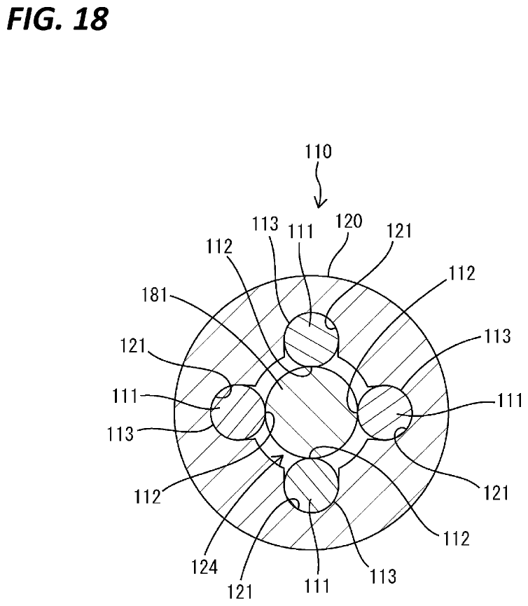

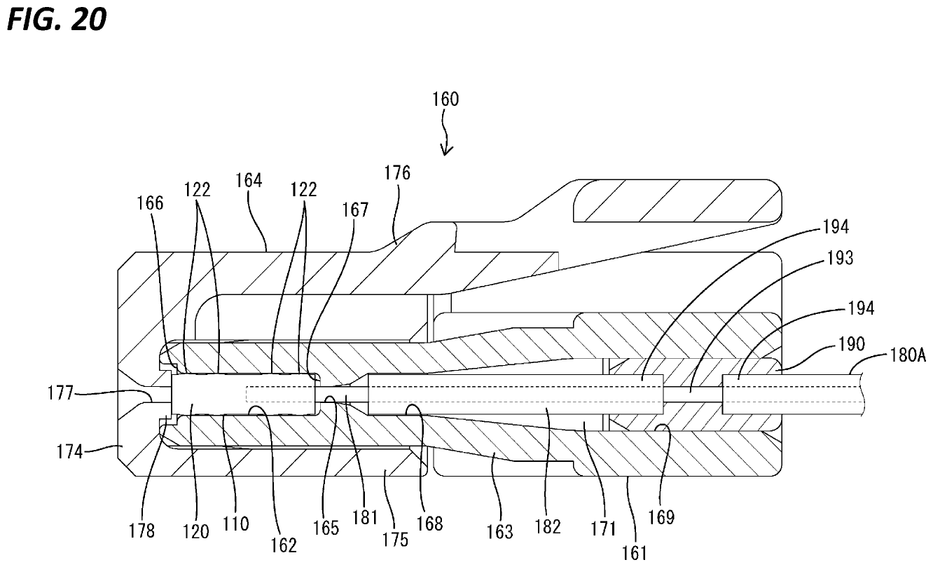

A connection device 110 according to the eighth embodiment includes a plurality of conductive portions 111 and a pressing member 120 as shown in FIG. 16. This connection device 110 is connected to electrically conductive members 181 and used as a part replacing conventional male and female terminal fittings as shown in FIG. 17. The connector 160 according to the eighth embodiment includes a connector housing 161 and a holding member 190 in addition to the above connection devices 110 as shown in FIG. 20.

<Conductive Portions 111>

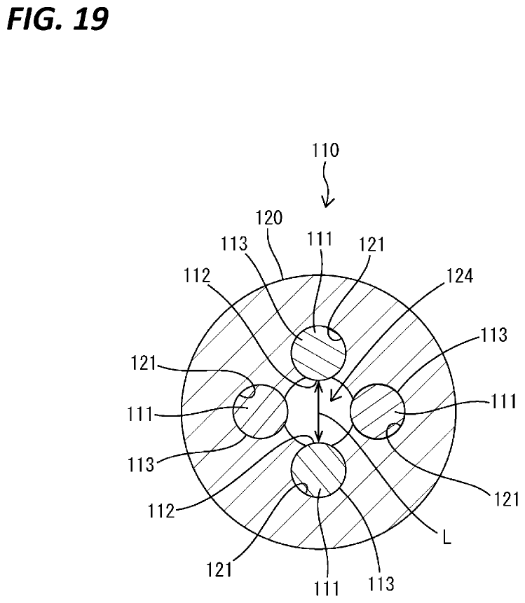

The conductive portion 111 is, for example, a linear member or rod-like member made of copper or aluminum. The plurality of conductive portions 111 are provided in the pressing member 120 of the connection device 110. The conductive portion 111 has a circular cross-section and linearly extends in the front-rear direction as shown in FIG. 17. As shown in FIG. 18, the conductive portion 111 includes a contact portion 112 along the front-rear direction on a semicircumference part of an outer peripheral surface on one side. The conductive portion 111 includes a held portion 113 on a semicircumference part of the outer peripheral surface on one side opposite to the contact portion 112. The held portion 113 is held by a later-described facing part 121 of the pressing member 120. The contact portion 112 contacts the mating electrically conductive member 181.

<Conductive Members 181>

As shown in FIG. 17, the electrically conductive member 181 is configured as a core part of a wire 180A, 180B. This electrically conductive member 181 is a single core made of metal such as copper or aluminum and has such rigidity to maintain a circular cross-section. The wire 180A, 180B includes an insulation coating 182 made of synthetic resin for covering the outer periphery of the electrically conductive member 181. The electrically conductive member 181 is exposed by stripping the insulation coating 182 in an end part of the wire 180A, 180B. In the case of the eighth embodiment, the wires 180A, 180B include a first wire 180A in which an exposed part of the electrically conductive member 181 is in contact with rear sides (right sides of FIG. 17) of the contact portions 112 of the conductive portions 111 and a second wire 180B in which an exposed part of the electrically conductive member 181 is in contact with front sides (left sides of FIG. 17) of the contact portions 112 of the conductive portions 111. A plurality of the first wires 180A and a plurality of the second wires 180B are connected via the respective conductive portions 111 while being arranged in the width direction.

<Pressing Members 120>

The pressing member 120 is a resilient member made of rubber elastomer such as silicon rubber and has a tubular shape extending in the front-rear direction. This pressing member 120 has an inner peripheral surface having a circular cross-section.

As shown in FIG. 19, the pressing member 120 includes a plurality of the facing parts 121 radially facing each other on the inner peripheral surface, and an entrance portion 124, into which the exposed parts of the electrically conductive members 181 enter, is formed between the respective facing parts 121. The respective facing parts 121 have an arc-shaped cross-section, in particular a superior arc-shaped cross-section, extend in the front-rear direction, and are open in the front and rear ends of the pressing member 120 and arranged at an interval of 90° on upper, lower, left and right sides. A distance (L) between the contact portions 112 of the facing conductive portions 111 in the respective facing parts 121 is smaller than diameters of the electrically conductive members 181 (see FIGS. 18 and 19) in a state before the exposed parts of the conductive portions 181 enter the entrance portion 124.

The held portion 113 of each conductive portion 111 is held while being fit in each facing part 121. For example, the held portion 113 is fit later into the facing part 121 or embedded in the facing part 121 by insert molding.

As shown in FIG. 16, the pressing member 120 includes a plurality of circulating lips 122 arranged at intervals in the front-rear direction on an outer peripheral surface. A pair of the lips 122 are provided in each of front and rear parts of the outer peripheral surface of the pressing member 120. Each lip 122 is held in close contact with the inner peripheral surface of a later-described cavity 162 of the connector housing 161.

The entrance portion 124 is provided to penetrate through the pressing member 120 in the front-rear direction. The pressing member 120 includes a first entrance end part 123A and a second entrance end part 123B serving as front and rear opening ends as shown in FIG. 17. The first entrance end part 123A is formed in a rear end part of the pressing member 120 and includes an opening into which the exposed part of the electrically conductive member 181 of the first wire 180A enters. The second entrance end part 123B is formed in a front end part of the pressing member 120 and includes an opening into which the exposed part of the electrically conductive member 181 of the second wire 180B enters. Each conductive portion 111 is formed to extend from the side of the first entrance end part 123A to the side of the second entrance end part 123B.

<Connector Housing 160>

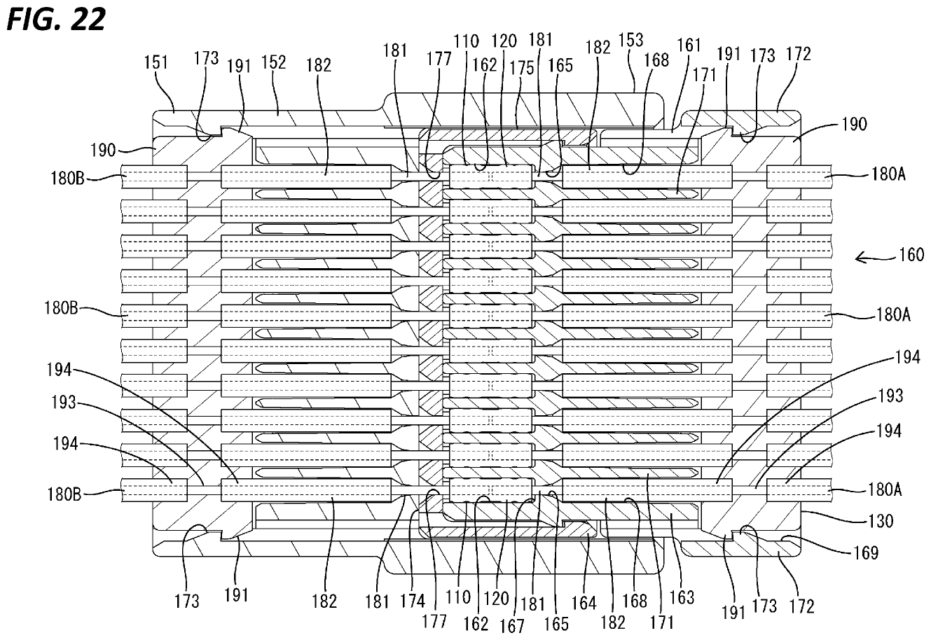

The connector housing 161 is made of synthetic resin and includes, as shown in FIG. 20, a housing body 163 and a front member 164 to be mounted on the housing body 163 from front. The housing body 163 has a flat shape along the width direction and includes a plurality of the cavities 162. As shown in FIG. 22, the plurality of cavities 162 are provided side by side in the width direction in a front part of the housing body 163. The respective cavities 162 extend in the front-rear direction and have front ends open in the front surface of the housing body 163 and rear ends communicating with respective through holes 165. The housing body 163 includes a plurality of recesses 166 recessed rearward in the front surface, and the respective cavities 162 are open in the back surfaces of the respective recesses 166. The connection device 110 is inserted and accommodated into the cavity 162 from front.

The through hole 165 is arranged at a position near the front part of the housing body 163. The through hole 165 is formed to have an opening diameter smaller than the cavity 162 and connected to the rear end of the cavity 162 via a step portion 167 extending along a radial direction. The connection device 110 contacts the step portion 167, whereby a rearward displacement is restricted.

The housing body 163 includes a plurality of relay holes 168 rearward of the respective cavities 162 and through holes 165. Each relay hole 168 extends in the front-rear direction and the front end thereof is reduced in diameter to have a tapered shape and communicates with the rear end of the through hole 165. A rear part of the relay hole 168 is formed to have a larger opening diameter than the cavity 162.

The first wire 180A is inserted into the relay hole 168 from behind. A front part of the insulation coating 182 of the first wire 180A is accommodated into the relay hole 168. A rear part of the exposed part of the electrically conductive member 181 in the first wire 180A is accommodated into the through hole 165, and a front part thereof is accommodated into the cavity 162. The front part of the exposed part of the electrically conductive member 181 in the first wire 180A is inserted into the connection device 110 (entrance portion 124) through the first entrance end part 123A in the cavity 162.

As shown in FIG. 22, the housing body 163 includes one accommodation hole 169 in a rear part. The accommodation hole 169 is open in the rear surface of the housing body 163. The rear end of each relay hole 168 is open to the accommodation hole 169. The rear ends of partition walls 171 partitioning between the respective relay holes 168 in the width direction are facing the accommodation hole 169. The housing body 163 includes a pair of widened portions 172 widened on both widthwise sides in a rear part. The accommodation hole 169 is provided inwardly of the respective widened portions 172 and accommodates the holding member 190.

The housing body 163 includes a pair of lock portions 173 on the inner surfaces (surfaces facing the accommodation hole 169) of the respective widened portions 172. Each lock portion 173 is in the form of a claw projecting into the accommodation hole 169.

The front member 164 is cap-shaped and includes, as shown in FIG. 20, a front wall portion 174 for covering the front surface of the housing body 163, a peripheral wall portion 175 for covering the outer peripheral surface of the front part of the housing body 163 and a lock arm 176 projecting rearward from an upper wall part of the peripheral wall portion 175. The front wall portion 174 includes a plurality of insertion holes 177 penetrating in the front-rear direction at positions corresponding to the respective cavities 162. Each insertion hole 177 has a circular cross-section and is formed to have an opening diameter smaller than each cavity 162. The opening diameter of the insertion hole 177 is equal to that of the through hole 165. The front wall portion 174 includes parts tapered and reduced in diameter from the front surface to the respective insertion holes 177.

As shown in FIG. 20, the front wall portion 174 includes a plurality of projecting portions 178 projecting rearward on a rear surface, and the respective insertion holes 177 penetrate through the respective projecting portions 178. The projecting portions 178 are fit and inserted into the recesses 166 of the housing body 163. With the connection device 110 accommodated in the cavity 162, a forward displacement of the connection device 110 is restricted by the contact of the pressing member 120 with the tip surface (rear end surface) of the projecting portion 178. The lock arm 176 holds a mating connector housing 151 seriving as a connection partner of the connector housing 161.

<Mating Connector Housing 151>

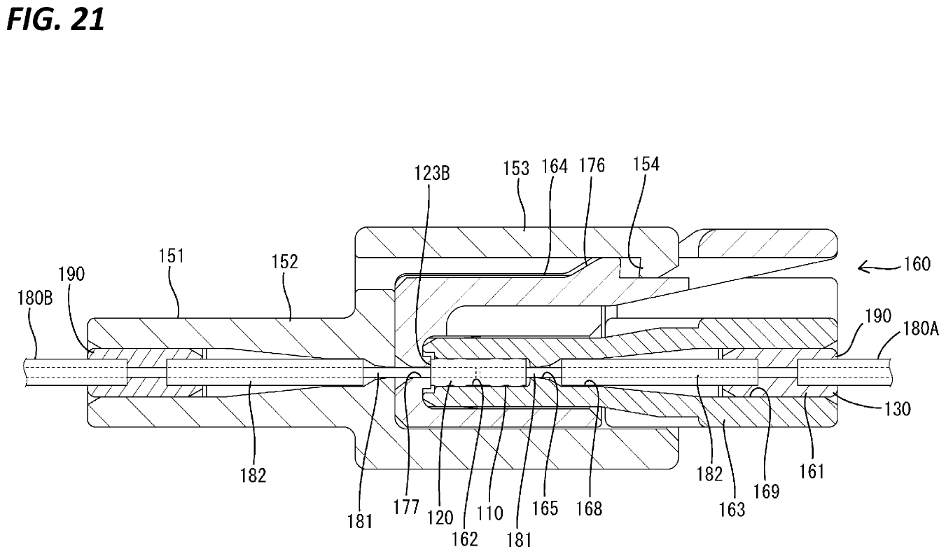

The mating connector housing 151 is made of synthetic resin and includes, as shown in FIGS. 21 and 22, a housing portion 152 having a flat shape along the width direction and a tubular receptacle 153 integrally projecting from the housing portion 152. The receptacle 153 includes a lock protrusion 154 to be locked to the lock arm 176 on the inner surface of an upper wall portion. The housing portion 152 includes parts similar to the respective cavities 162, the respective through holes 165, the respective relay holes 168 and the accommodation hole 169 in the housing body 163 and accommodates and holds the respective second wires 180B and the holding member 190. Exposed parts of the electrically conductive members 181 of the respective second wires 180B are arranged to project into the receptacle 153 from a back surface.

<Holding Member 190>

As shown in FIG. 24, the holding member 190 has a flat shape along the width direction and collectively holds the respective wires 180A, 180B arranged laterally side by side. The holding member 190 is a molded body formed by covering the respective wires 180A, 180B with a resin. Relative position shifts of the respective wires 180A, 180B are restricted via the holding member 190 and the wires 180A, 180B are held at fixed intervals in the width direction. The holding member 190 includes a pair of locked portions 191 on both side surfaces. Each locked portion 191 is in the form of a claw projecting outward in the width direction.

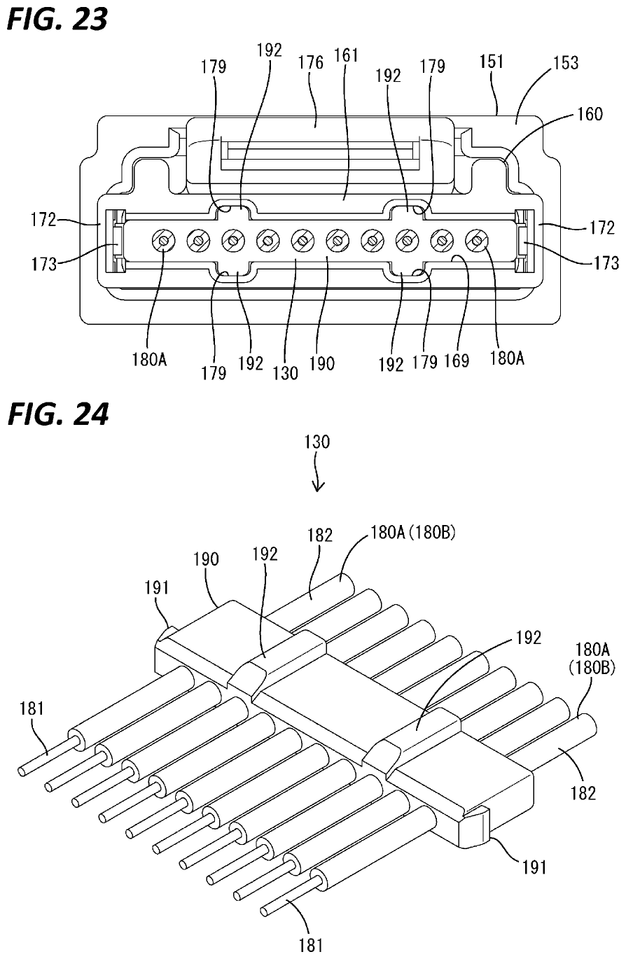

The holding member 190 is entirely inserted into the accommodation hole 169 of the connector housing 161. The respective locked portions 191 are resiliently locked by the respective lock portions 173. In this way, the holding member 190 is retained and held in the accommodation hole 169 of the connector housing 161. The holding member 190 includes a pair of ribs 192 on each of upper and lower surfaces. The respective ribs 192 are formed to extend in the front-rear direction on the upper and lower surfaces. As shown in FIG. 23, the respective ribs 192 are inserted into receiving grooves 179 formed in the upper and lower surfaces of the accommodation hole 169 when the holding member 190 is inserted into the accommodation hole 169 of the connector housing 161.

As shown in FIG. 22, the holding member 190 molds intermediate stripped portions 193 of the respective wires 180A, 180B. The intermediate stripped portions 193 are formed on the electrically conductive members 181 exposed by removing the insulation coatings 182 in intermediate parts (halfway parts) in the front-rear direction of the wires 180A, 180B. The holding member 190 molds adjacent parts of the insulation coatings 182 arranged in front of and behind the intermediate stripped portions 193 in addition to the intermediate stripped portions 193. A step is formed between an end surface of the adjacent portion 194 of the insulation coating 182 and the intermediate stripped portion 193. The end surfaces (steps) of the adjacent portions 194 of the insulation coatings 182 are arranged along a direction perpendicular to the front-rear direction inside the holding member 190, whereby the respective wires 180A, 180B are retained in the holding member 190.

<Functions of Connection Device 110 and Connector 160>

Prior to assembling into the connector housing 161, the intermediate parts of the respective first wires 180A are molded with the resin. In this way, a molded body 130 in which the respective first wires 180A and the holding member 190 are integrated is formed as shown in FIG. 24. The respective first wires 180A in the molded body 130 are aligned and held at fixed intervals in the width direction and the tip positions of the exposed parts of the respective electrically conductive members 181 are aligned.

The plurality of connection devices 110 are respectively inserted into the respective cavities 162 of the housing body 163. Rearward escape of the connection devices 110 is restricted by the step portions 167. Then, the front member 164 is mounted on the housing body 163, whereby forward escape of the connection devices 110 is also restricted by the front wall portion 174 of the front member 164.

In the above state, the molded body 130 is inserted into the accommodation hole 169 of the connector housing 161 from behind. The holding member 190 contacts the rear surfaces of the respective partition walls 171 and the respective locked portions 191 of the holding member 190 are locked by the respective lock portions 173 of the connector housing 161, whereby the molded body 130 is held in the connector housing 161.

The front parts of the insulation coatings 182 of the respective first wires 180A are accommodated into the respective relay holes 168, and the exposed parts of the electrically conductive members 181 of the respective first wires 180A are accommodated from the respective through holes 165 to the respective cavities 162. The front part of the exposed part of the electrically conductive member 181 in the first wire 180A is inserted into the connection device 110 through the first entrance end part 123A and enters the entrance portion 124 in the cavity 162. The tip of the exposed part of the electrically conductive member 181 of the first wire 180A is arranged behind a center in the front-rear direction of the connection device 110 (see FIGS. 17 and 20). As shown in FIG. 18, each conductive portion 111 contacts the exposed part of the electrically conductive member 181 having entered the entrance portion 124 while receiving a force acting radially inward (reaction force, resilient force) from the pressing member 120. Specifically, the respective conductive portions 111 sandwich the electrically conductive member 181 in facing directions (vertical direction and lateral direction) from the respective facing parts 121 and contact the electrically conductive member 181 along the front-rear direction. The pressing member 120 gives a large pressing force to the electrically conductive member 181 by the respective lips 122 being held in close contact with the inner peripheral surface of the cavity 162 and resiliently squeezed. The electrically conductive member 181 obtains the large pressing force at a position corresponding to the respective lips 122 in the rear part and contacts the contact portions 112 of the respective conductive portions 111. Thus, the electrically conductive member 181 and the respective conductive portions 111 can secure and maintain a predetermined contact pressure via the pressing member 120.

Subsequently, the connector housing 161 is fit into the receptacle 153 of the mating connector housing 151. As shown in FIG. 21, the lock arm 176 resiliently locks the lock protrusion 154, whereby the both connector housings 151, 161 are held with separation restricted.

Before the both connector housings 151, 161 are connected, the respective second wires 150B are accommodated in the mating connector housing 151 while being held by the holding member 190, similarly to the respective first wires 180A. The respective second wires 180B are arranged in the same alignment as the respective first wires 180A.

When the both connector housings 151, 161 are connected, the exposed parts of the electrically conductive members 181 of the second wires 180B are accommodated into the cavities 162 through the insertion holes 177 of the front wall portion 174. The exposed parts of the electrically conductive members 181 of the second wires 180B enter the entrance portions 124 through the second entrance end parts 123B in the cavities 162. The tips of the exposed parts of the electrically conductive members 181 in the second wires 180B are arranged forward of centers in the front-rear direction of the connection devices 110. The electrically conductive members 181 of the second wires 180B contact the contact portions 112 of the respective conductive portions 111 in a manner similar to the electrically conductive members 181 of the aforementioned first wires 180A. In this way, the electrically conductive members 181 of the respective second wires 180B contact the contact portions 112 of the respective conductive portions 111, whereby the electrically conductive members 181 of the respective first wires 180A and the electrically conductive members 181 of the respective second wires 180B are connected via the connection devices 110 (see FIGS. 21 and 22).

The exposed parts of the electrically conductive members 181 of the second wires 180B are pulled out from the entrance portions 124 of the connection devices 110 when the both connector housings 151, 161 are separated. Further, the exposed parts of the electrically conductive members 181 of the first wires 180A are pulled out from the entrance portions 124 of the connection devices 110 when the molded body 130 is taken out from the accommodation hole 169. That is, the electrically conductive members 181 can be inserted into and withdrawn from the entrance portions 124 of the connection devices 110.

As described above, according to the eighth embodiment, the connection device 110 includes the pressing member 120 and the conductive portions 111, and the pressing member 120 gives a force for pressing the conductive portions 111 against the electrically conductive member 181 to the conductive portions 111. The conductive portions 111 receive the force of the pressing member 120 and are pressed into contact with the electrically conductive members 181 of the wire 180A, 180B. In a conventional case, crimping pieces of a terminal fitting are crimped to a core part, which possibly becomes an electrically conductive member, to secure a contact pressure between the core part and the terminal fitting. In contrast, in the case of the eighth embodiment, the contact pressure between the electrically conductive member 181 and the conductive portions 111 is secured by the force of the pressing member 120 itself. Thus, a crimping step can be omitted. Further, the connection device 110 does not include parts equivalent to the crimping pieces in the conventional terminal fitting, and has a simple and compact structure.

Further, since the pressing member 120 is made of non-metal, connected parts of the conductive portions 111 and the electrically conductive member 181 need not be insulated. Thus, the connection device 110 needs not be provided with a separate insulating structure. Moreover, the pressing member 120 presses the conductive portions 111 against the electrically conductive member 181 by a relatively simple structure. As a result, the enlargement of the connection device 110 can be avoided. Particularly, since the pressing member 120 is made of elastomer, a degree of freedom in molding is high and resilience is easily adjusted.

The pressing member 120 includes the entrance portion 124 inside, and the conductive portions 111 are provided in the entrance portion 124. In this way, the electrically conductive member 181 and the conductive portions 111 can be easily connected only by causing the electrically conductive member 181 to enter the entrance portion 124.

Further, the conductive portions 111 are arranged along the front-rear direction, which is an entering direction of the electrically conductive member 181. In this way, external matters such as dust adhering to the surface of the electrically conductive member 181 can be wiped and removed by the conductive portions 111 in the entering process of the electrically conductive member 181 into the entrance portion 124.

The conductive portions 111 include the held portions 113 held in the facing parts 121 of the pressing member 120 and are integrated with the pressing member 120. Thus, the connection device 110 can be integrally handled. Further, the conductive portions 111 are arranged in the respective facing parts 121 of the pressing member 120 and contact the electrically conductive member 181 from the respective facing parts 121. Thus, a connected state of the conductive portions 111 and the electrically conductive member 181 can be stably maintained.

Further, the entrance portion 124 is provided as a space penetrating through the pressing member 120 in the front-rear direction. The pressing member 120 includes the entrance end parts 123A, 123B constituting the front and rear end parts of the entrance portion 124, and the conductive portions 111 are arranged to extend between the respective entrance end parts 123A and 123B of the pressing member 120. The exposed parts of the electrically conductive members 181 of the respective wires 180A, 180B enter the entrance portion 124 through the entrance end parts 123A, 123B and contact the conductive portions 111. Thus, the electrically conductive members 181 of the respective wires 180A, 180B are easily connected via the conductive portions 111.

The connection device 110 is inserted and accommodated into the cavity 162 of the connector housing 161. The electrically conductive members 181 of the respective wires 180A, 180B extend to the outside of the connection device 110 and are held aligned with each other outside by the holding member 190. Since the electrically conductive members 181 of the respective wires 180A, 180B and the holding member 190 are integrated as the molded body 130, these are excellent in handleability. The holding member 190 includes the locked portions 191 to be locked to the connector housing 161. The connection devices 110 are provided separately from the holding member 190 and do not include parts equivalent to the locked portions 191. Thus, the structure of the connection devices 110 can be more simplified.

The pressing member 120 is resiliently compressed by the connector housing 161. Thus, the pressing member 120 can give a predetermined force to the electrically conductive members 181 and the connected state of the conductive portions 111 and the electrically conductive members 181 is more stabilized. Further, the waterproofness of the connected parts of the conductive portions 111 and the electrically conductive members 181 can be ensured by the pressing member 120.

The pressing member 120 is made of elastomer and resiliently compressed by the connector housing 161. According to this configuration, when the connection device 110 is accommodated into the connector housing 161, the conductive portions 111 can obtain a force from the pressing member 120 and stably contact the electrically conductive members 181. Further, the waterproofness of the connected parts of the conductive portions 111 and the electrically conductive members 181 can be ensured by the pressing member 120.

### Other Embodiments

The present invention is not limited to the above described and illustrated first to eighth embodiments and is represented by claims. The present invention is intended to include all changes in the scope of claims and in the meaning and scope of equivalents and also include the following embodiments.

Although the movable-side conductive member is a plate-like member made of metal such as copper and aluminum in the first to seventh embodiments, the movable-side conductive member may be a linear member or rod-like member made of metal or may be an electrically conductive member made of a metal foil of copper, aluminum or the like, carbon powder, carbon nanotubes and to be applied to the pressing member.

Although the pressing member is made of rubber in the first to seventh embodiments, the pressing member may be made of synthetic resin without being limited to the one made of rubber.

Although the first and second conductors are single cores in the first to seventh embodiments, the first and second conductors may be configured by binding stranded wires by ultrasonic welding, laser welding or the like without being limited to single cores or may be busbars made of a metal plate material.

In the first to seventh embodiments, the connection device may include, for example, a water stop member such as a heat shrinkable tube in addition to the movable-side conductive member(s), the fixed-side conductive member(s) and the pressing member(s). The water stop member may be mounted to cover the first and second conductors exposed between the pressing member(s) and the insulation coatings.

Although the movable-side conductive member configured to be displaced integrally with the pressing member and the fixed-side conductive member fixed to the female housing are brought into contact with the first and second conductors in the first embodiment, only the movable-side conductive member may be brought into contact with the first and second conductors or only the fixed-side conductive member may be brought into contact with the first and second conductors.

In the first embodiment, both the movable-side conductive member and the fixed-side conductive member may be provided with contact point portions.

The configuration of the second embodiment to form the rib-like contact point portion on the movable-side conductive member can be applied to the third to seventh embodiments.

The configuration of the fourth embodiment to integrally couple the plurality of fixed-side conductive members via the coupling portions can also be applied to the first, second and fifth to seventh embodiments.

The configuration of the fifth to seventh embodiments to integrate the plurality of movable-side conductive members with one pressing member can also be applied to the first to fourth embodiments.

Although the conductive portion 111 is a linear member or rod-like member made of metal in the eighth embodiment, the conductive portion may be, for example, a plate-like member (flat plate member, curved plate member or the like) made of metal such as copper or aluminum or may be an electrically conductive member made of a metal foil of copper, aluminum or the like, carbon powder, carbon nanotubes or the like and to be applied to the pressing member as another embodiment.

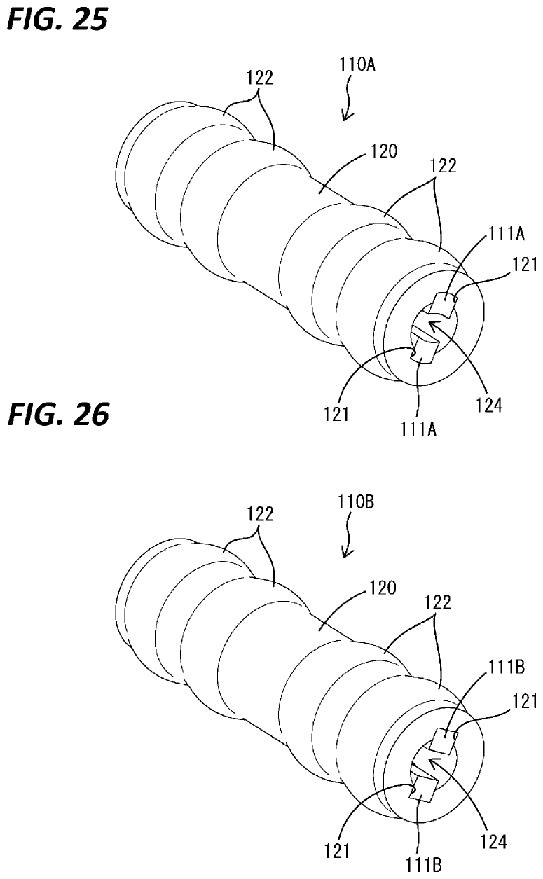

For example, in the case of a first modification of a connection device 110A shown in FIG. 25, a conductive portion 111A is a curved plate member made of metal and has an arc-shaped cross-section and a pair of the conductive portions 111A are provided in facing parts 121 arranged at an interval of 180° in a circumferential direction in a pressing member 120. Further, in the case of a second modification of a connection device 110B shown in FIG. 26, a conductive portion 111B is a flat plate member and has a rectangular cross-section (in particular, a square cross-section) and a pair of the conductive portions 111B are provided in facing parts 121 arranged at an interval of 180° in a circumferential direction in a pressing member 120.

Although the pressing member 120 is formed into a tubular shape in the case of the eighth embodiment, a pressing member may be, for example, plate-like (flat plate-like, curved plate-like) resilient members arranged to face each other on the inner peripheral surface of the cavity 162 of the connector housing 161 without being limited to the one having a tubular shape as another embodiment.

Although the pressing member 120 is made of rubber in the eighth embodiment, a pressing member may be made of synthetic resin without being limited to the one made of rubber as another embodiment.

Although the electrically conductive members 181 are the single cores of the wires 180A, 180B in the case of the eighth embodiment, electrically conductive members may be configured by binding stranded wires by ultrasonic welding, laser welding or the like or may be busbars as another embodiment without being limited to single cores.

Although the pressing member 120 includes two entrance end parts 123A, 123B, into which the electrically conductive members 181 enter, in the case of the eighth embodiment, the pressing member 120 may include, for example, only one entrance end part, into which the electrically conductive member 181 enters, or may include three or more entrance end parts as another embodiment. If there is one entrance end part, the conductive portions may be, for example, busbars including a ground connecting portion to be connected to a grounding member separately from the contact portions 112 configured to contact the electrically conductive member 181.

Although the connection device 110 is composed of the conductive portions 111 and the pressing member 120 in the case of the eighth embodiment, the connection device 110 may include a water stop member such as a heat shrinkable tube in addition to the conductive portions 111 and the pressing member 120 as another embodiment. The water stop member may be mounted to cover the electrically conductive members 181 exposed between the pressing member 120 and the insulation coatings 182.

Although the entrance portion 124 is provided as a space penetrating through the pressing member 120 in the front-rear direction in the case of the eighth embodiment, an entrance portion may be merely a cut formed in a body portion as another embodiment.

### LIST OF REFERENCE NUMERALS

F . . . female connector

M . . . male connector

10 . . . female housing

11 . . . housing body

12 . . . front member

13 . . . cavity

14 . . . connecting portion (supporting portion)

15 . . . positioning portion

16 . . . groove portion

17 . . . guide portion

18 . . . inserting portion

19 . . . retaining projection

20 . . . holding space

21 . . . front wall portion

22 . . . peripheral wall portion

23 . . . lock arm

24 . . . insertion hole

30 . . . connection device

31 . . . pressing member

32 . . . accommodation recess

35 . . . movable-side conductive member (first conductive portion)

36 . . . first contact portion

37 . . . second contact portion

38 . . . coupling portion

39 . . . bent end part

40 . . . fixed-side conductive member (second conductive portion)

41 . . . mounting portion

42 . . . first contact point portion

43 . . . second contact point portion

45 . . . first wire module

46 . . . first coated wire

47 . . . first conductor (electrically conductive member)

47E . . . first connecting end part

48 . . . first insulation coating

49 . . . first holding member (holding member)

50 . . . locking projection

60 . . . male housing

61 . . . housing portion

62 . . . receptacle

63 . . . lock portion

64 . . . second wire module

65 . . . second coated wire

66 . . . second conductor (electrically conductive member)

66E . . . second connecting end part

67 . . . second insulation coating

68 . . . second holding member (holding member)

70 . . . movable-side conductive member (first conductive portion)

71 . . . contact point portion

72 . . . connection device

73 . . . second pressing member

74 . . . second movable-side conductive member (second conductive portion)

75 . . . joint terminal

76 . . . linking portion

77 . . . pressing member

78 . . . movable-side conductive member (first conductive portion)

79 . . . pressing module

80 . . . movable-side conductive member (first conductive portion)

81 . . . linking portion

82 . . . joint terminal

83 . . . pressing module

84 . . . movable-side conductive member (first conductive portion)

85 . . . linking portion

86 . . . joint terminal

87 . . . pressing module

110 . . . connection device

110A . . . connection device

110B . . . connection device

111 . . . conductive portion

111A . . . conductive portion

111B . . . conductive portion

112 . . . contact portion

113 . . . held portion

120 . . . pressing member

121 . . . facing part

122 . . . lip

123A . . . first entrance end part

123B . . . second entrance end part

124 . . . entrance portion

130 . . . molded body

151 . . . mating connector housing

152 . . . housing portion

153 . . . receptacle

154 . . . lock protrusion

160 . . . connector

161 . . . connector housing

162 . . . cavity

163 . . . housing body

164 . . . front member

165 . . . through hole

166 . . . recess

167 . . . step portion

168 . . . relay hole

169 . . . accommodation hole

171 . . . partition wall

172 . . . widened portion

173 . . . lock portion

174 . . . front wall portion

175 . . . peripheral wall portion

176 . . . lock arm

177 . . . insertion hole

178 . . . projecting portion

179 . . . receiving groove

180A . . . first wire

180B . . . second wire

181 . . . electrically conductive member

182 . . . insulation coating

190 . . . holding member

191 . . . locked portion

192 . . . rib

193 . . . intermediate stripped portion

194 . . . adjacent portion

884 . . . movable-side conductive member

1. A connection device, comprising:
a conductive portion configured to electrically contact an electrically conductive member serving as a connection object; and
a pressing member made of resilient non-metal, the pressing member giving a pressing force in a contact direction to the electrically conductive member and the conductive portion,
a plurality of the conductive portions being mounted in one pressing member.

2. A connection device, comprising:
a conductive portion configured to electrically contact an electrically conductive member serving as a connection object; and
a pressing member made of resilient non-metal, the pressing member giving a pressing force in a contact direction to the electrically conductive member and the conductive portion,
the conductive portion including a first conductive portion and a second conductive portion arranged to face the first conductive portion across the electrically conductive member, and
at least either a plurality of the first conductive portions or a plurality of the second conductive portions being conductively coupled to each other.

3. A connection device, comprising:
a conductive portion configured to electrically contact an electrically conductive member serving as a connection object;
a pressing member made of resilient non-metal, the pressing member giving a pressing force in a contact direction to the electrically conductive member and the conductive portion; and
a supporting portion configured to support the pressing member,
the conductive portion including a first conductive portion and a second conductive portion arranged to face the first conductive portion across the electrically conductive member,
the first conductive portion being displaceable integrally with the pressing member, and
the second conductive portion being fixed to the supporting portion.

4. The connection device of claim 2, comprising a second pressing member located on a side opposite to the pressing member across the electrically conductive member, wherein:
the first conductive portion is displaceable integrally with the pressing member and the second conductive portion is displaceable integrally with the second pressing member.

5. The connection device of claim 2, wherein at least one of the first and second conductive portions is formed with a projection-like contact point portion configured to contact the electrically conductive member.

6. The connection device of claim 3, wherein a projection-like contact point portion configured to contact the electrically conductive member is formed on only the second conductive portion, out of the first and second conductive portions.

7. The connection device of claim 2, wherein a plurality of the conductive portions are mounted in one pressing member.

8. The connection device of claim 3, wherein at least either a plurality of the first conductive portions or a plurality of the second conductive portions are conductively coupled to each other.

9. A connection device, comprising:
a conductive portion configured to electrically contact an electrically conductive member serving as a connection object; and
a pressing member made of resilient non-metal, the pressing member giving a pressing force in a contact direction to the electrically conductive member and the conductive portion,
the pressing member including an entrance portion penetrating through the pressing member, the electrically conductive member being able to enter the entrance portion,
a facing part having an arc-shaped cross-section being formed in an inner peripheral surface of the entrance portion, and
the conductive portion being held in the facing part.

10. The connection device of claim 9, wherein:
the pressing member includes a plurality of entrance end parts constituting end parts of the entrance portion, and
the conductive portion is arranged to extend between the plurality of entrance end parts.

11. The connection device of claim 9, wherein the entrance portion is a space penetrating through the pressing member in an entering direction of the electrically conductive member.

12. A connector, comprising:
the connection device of claim 1;
a connector housing configured to accommodate the connection device; and
a holding member configured to hold the electrically conductive member,
the holding member including a locked portion, and
the connector housing including a lock portion configured to lock the locked portion and restrict escape of the holding member from the connector housing.

13. The connector of claim 12, wherein the holding member is made of mold resin configured to collectively mold a plurality of the electrically conductive.
